(19) United States
(12) Patent Application Publication
(10) Pub. No.: US 2013/0213202 A1
(43) Pub. Date: Aug. 22, 2013

(54) CUTTER

(71) Applicant: Lawrence Crainich, Charlestown, NH (US)

(72) Inventor: Lawrence Crainich, Charlestown, NH (US)

(73) Assignee: VERMONT INSTRUMENT MAKERS, LLC, Occidental, CA (US)

(21) Appl. No.: 13/879,191

(22) PCT Filed: Oct. 14, 2011
(86) PCT No.: PCT/US11/56419

§ 371 Date: Apr. 12, 2013

Related U.S. Application Data
(60) Provisional application No. 61/393,289, filed on Oct. 14, 2010.

(51) Int. Cl. B26B 17/02

(52) U.S. Cl. CPC B26B 17/02
USPC 83/51; 30/186; 30/191; 30/346; 30/193

(57) ABSTRACT

A cutter for cutting a member has a first jaw and a second jaw mounted relative to each other to articulate along a range of motion between an open condition and a closed condition. The jaws are configured to provide a shearing action cutting between the first jaw and the second jaw on a first side of the member and an opposite shearing action cutting on an opposite second side of the member. In a single stroke cutting method the edges come together. They may be at an angle off-parallel to each other or oppositely stepped and intersecting in superposition. With centrally recessed edges, there may be opposite bypass cutting on opposite sides of the member. In a central region between the first side and the second side, there may be no bypass (e.g., approach being more conventional non-bypass cleaving).

### CROSS-REFERENCE TO RELATED APPLICATION

Benefit is claimed of U.S. Patent Application Ser. No. 61/393,289, filed Oct. 14, 2010, the disclosure of which is incorporated by reference in its entirety herein as if set forth at length.

### BACKGROUND OF THE INVENTION

The invention relates to cutting of metallic shafts. More particularly, the invention relates to cutting shafts of surgical implants and the like.

There are a plurality of mechanical cutting techniques. In a scissors cutting action, two blades progressively overlap at an angle to their cutting edges. Each blade has an exemplary flat first face facing the associated first face of the other blade and, along the edge, an angle ground in a second face. During the cutting action, the blades bypass each other. Similar bypass is used in a variety of cutting devices including certain metalworking shears.

Other cutting techniques do not involve bypass. In an exemplary anvil-style shears, an exemplary doubly ground blade approaches a flat anvil. The material to be cut is trapped between the blade and anvil. The blade edge causes a local stress concentration in the material to cleave the material. A somewhat similar action occurs when there are two such blades approaching each other with their edges coplanar. The stress concentrations from the respective blade edges can occur on opposite sides of the material to cleave the material. Other metalworking shears and bolt and rod cutters take this form. The edges of such a cutter may be singly ground or doubly ground. The two faces of the blade(s) or jaw(s) may be symmetric or asymmetric depending upon implementation.

One particular area of cutting has involved titanium-based rods (also cobalt-based and stainless steel) used in orthopedic fixation systems. These have often been cut with a device based on a traditional bolt cutter. Exemplary such bolt cutters are seen in U.S. Pat. No. 6,085,425, the disclosure of which is incorporated by reference herein in its entirety as if set forth at length. A commercial example of such a device is seen in the Biomet, Inc. spinal rod cutter.

### SUMMARY OF THE INVENTION

One aspect of the disclosure involves a method for cutting a metallic shaft. Two opposed cutting edges come together at an angle off-parallel to each other and intersecting in superposition. With concave edges, in a single stroke, first and second jaws of a cutter perform a first bypass cutting along a first side of the metallic shaft and an opposite bypass cutting on the second side of the metallic shaft opposite the first side. In a central region between the first side and the second side, there may be no bypass (e.g., approach being more conventional non-bypass cleaving).

Another aspect of the disclosure involves a cutter having a first jaw having a first edge having first and second portions and a second jaw having a second edge having first and second portions. The first and second jaws are mounted relative to each other to articulate along a range of motion between an open condition and a closed condition. The first jaw first edge portion is offset from the second jaw first edge portion and the first jaw second edge portion is oppositely offset from the second jaw second edge portion. In various implementations of the foregoing implementations, centers of the respective first and second jaws may move in a cutting plane. The first and second edges may be respectively off-parallel to the cutting plane and to each other.

During a terminal portion of a range of motion approaching a closed condition, the first and second edges may progressively overlap in superposition normal to the cutting plane. The first and second edges may be arcuate. They may be concavely arcuate or otherwise centrally recessed. Central portions of the first and second edges may be off-parallel to each other by an exemplary at least 20° and may intersect when projected on a central transverse plan of the jaws. The first and second edges may be edges of respective first and second inserts of a first pair of inserts in respective jaw bodies of the first and second jaws. The cutter may have a first handle and a second handle. A compound hinge mechanism may couple the first handle and second handle to the first jaw and second jaw to magnify a compressive force applied across the handles into a greater compressive force applied by the jaw bodies across the inserts to cut a workpiece. The hinge mechanism may include a equipost coupling the jaws to prevent racking of the jaws. The cutting system may include such a cutter and at least one additional pair of inserts interchangeable with the first pair of inserts and having edges of different form to those of the first pair of inserts. The different form may involve arcuate edges of different curvatures to edge curvature of the first pair of inserts. Each system may include a further pair of inserts having non-arcuate edges (whereas the first pair of inserts have arcuate edges).

Another aspect of the disclosure involves a cutter for cutting a member (e.g., an elongate member such as a bolt, shaft, or the like). The cutter comprises a first jaw and a second jaw mounted relative to each other to articulate along a range of motion between an open condition and a closed condition. The jaws are configured to provide a shearing action cutting between the first jaw and the second jaw on a first side of the member and an opposite shearing action cutting between the first jaw and the second jaw on a second side of the member opposite the first side. In various implementations, the first side may be away from the hinge of a cutter and the second side may be toward the hinge. The shearing action on the first side may comprise a bypass cutting and the opposite shearing action on the second side may comprise an opposite bypass cutting. The cutting action may consist of or consist essentially of such two shearings.

Another aspect of the disclosure involves a method for cutting a member (e.g., a metallic shaft). The method comprises, in a single stroke: a shearing action (e.g., a bypass cutting) between a first jaw and a second jaw on a first side of the member; and an opposite shearing action between the first jaw and the second jaw on a second side of the member opposite the first side.

In various implementations, in a region between the first side and second side, there may be no bypass. The metallic shaft may be a titanium-based, cobalt-based, or stainless steel shaft and/or may be a rod of a spinal implant.

Another aspect of the invention involves a tool comprising a first jaw having a first face and a second face and a second jaw having a first face and a second face. A hinge mechanism couples the first and second jaws for rotation relative to each other about a hinge axis and comprises a first annular channel in the first faces of the first and second jaws and a second annular channel in the second faces of the first and second jaws. A first side member has an annular protrusion accommodated the first annular channel. A second side member has an annular protrusion accommodated in the second annular channel.

In various implementations, an actuator may comprise a first handle pivotally coupled to the first jaw for relative rotation about a first axis and a second handle pivotally coupled to the second jaw for relative rotation about a second axis and pivotally coupled to the first handle for relative rotation about a handle pivot axis. The first and second jaws may each comprise a jaw body and a cutting insert. Each cutting insert may comprise a cutting portion and a retaining portion. The retaining portion may be arcuate and accommodated in the associated jaw body radially inboard of the first and second channels with respect to the hinge axis. The arcuate portions may combine to encircle at least 270° of a shaft member coupling the first and second side members.

Another aspect of the disclosure involves a cutting insert for use with a tool. The cutting insert comprises a cutting portion and an arcuate retaining portion for retaining the cutting insert to the tool. In various implementations of the cutting insert, one to all of: the cutting insert consists essentially of the cutting portion and the retaining portion; the cutting portion has a cutting edge off-normal to an axis of curvature of the arcuate retaining portion; the cutting portion has a first edge and a second edge offset from the first edge; the cutting insert consists essentially of a single metallic piece; the cutting portion has an arcuate cutting edge; the cutting portion has a cutting edge having a central recess; the cutting insert is a unisex moiety; the cutting portion comprises a cutting edge protruding from a concave surface of an arcuate body portion; the retaining portion has a concave surface extending at least 90° about an axis of curvature; a pair of said cutting inserts are packaged together; and first and second said cutting inserts are attached to respective first and second jaws of the tool.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a test fixture first cutter.

FIG. 2 is a cutaway axial sectional view of the first cutter.

FIG. 3 is an exploded view of the first cutter.

FIG. 4 is a central axial sectional view of the first cutter.

FIG. 5 is a transverse sectional view of the cutter of FIG. 4, taken along line 5-5.

FIG. 6 is a view of a pair of alternate cutting inserts for the first cutter.

FIG. 7 is an end view of one of the inserts of FIG. 6 showing an outline of a second insert in broken lines.

FIG. 8 is a schematic illustration showing shearing action and yawing moments for an X-pattern cutter and an H-pattern cutter.

FIG. 9 is a view of a pair of second alternate inserts for the cutter of FIG. 1.

FIG. 10 is a view of one of the inserts of FIG. 9.

FIG. 11 is a view of a hand-actuated second cutter in a closed condition.

FIG. 12 is a second view of the second cutter.

FIG. 13 is an exploded view of the second cutter.

FIG. 14 is an exploded view of cutting inserts and retention clips of the second cutter along with a rod to be cut.

FIG. 15 is a side view of the working end of the second cutter in a closed condition.

FIG. 16 is a sectional view of the second cutter, taken along line 16-16 of FIG. 15.

FIG. 17 is a view of the cutting insert for the second cutter in an early stage of manufacture.

FIG. 18 is a view of the insert in a subsequent stage of manufacture.

FIG. 19 is a view of the insert in a subsequent stage of manufacture.

FIG. 20 is a view of a fixture for use in manufacturing the inserts of the second cutter.

FIG. 21 is a view of a body of the fixture of FIG. 20.

FIG. 22 is a top view of the fixture of FIG. 20.

FIG. 23 is an oblique frontal view of the fixture of FIG. 20.

FIG. 24 is a face view of an alternate cutting insert for the second cutter.

FIG. 25 is an end view of the insert of FIG. 24.

FIG. 26 is an oblique view of the insert of FIG. 24 taken along line 26-26.

FIG. 27 is a view of a hand-actuated third cutter in a closed condition.

FIG. 28 is an exploded view of the third cutter.

FIG. 29 is a sectional view of the working end of the third cutter of FIG. 27 taken along line 29-29.

FIG. 29A is an enlarged view of a portion of FIG. 29.

FIG. 30 is a first sectional view of the working end of the third cutter of FIG. 27, taken along line 30-30.

FIG. 30A is an enlarged view of a portion of FIG. 30.

FIG. 31 is a first exploded view of the working portion of the third cutter.

FIG. 32 is a second exploded view of the third working portion of the cutter.

FIG. 33 is a view of the working portion of the cutter with a side member/cap removed.

FIG. 33A is an enlarged view of a portion of FIG. 33.

FIG. 34 is an open view of the third cutter.

FIG. 35 is a view of a cutting insert for the third cutter.

FIG. 36 is a face view of the cutting insert of FIG. 35.

FIG. 37 is a sectional view of the insert of FIG. 36, taken along line 37-37.

FIG. 38 is a side view of the cutting insert of FIG. 35.

FIG. 39 is an oblique view of the insert of FIG. 38.

FIG. 40 is a view of an alternate insert for the third cutter.

FIG. 41 is a view of a second alternate insert for the third cutter.

FIG. 42 is a view of a third alternate insert for the third cutter.

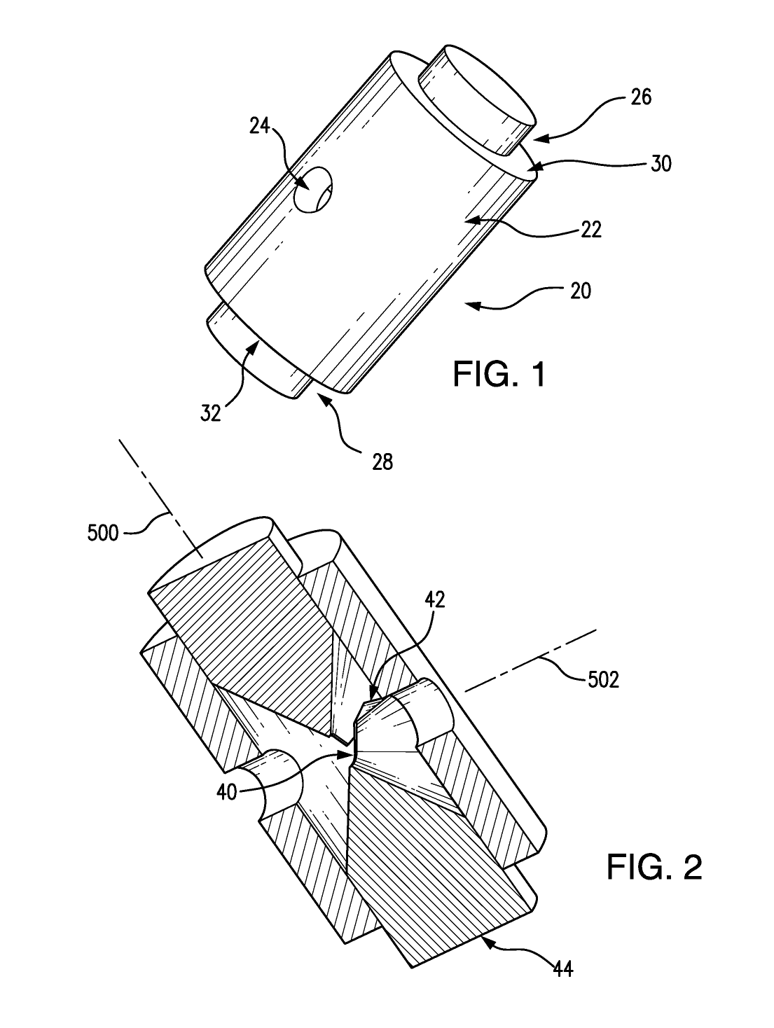

Like reference numbers and designations in the various drawings indicate like elements.

### DETAILED DESCRIPTION

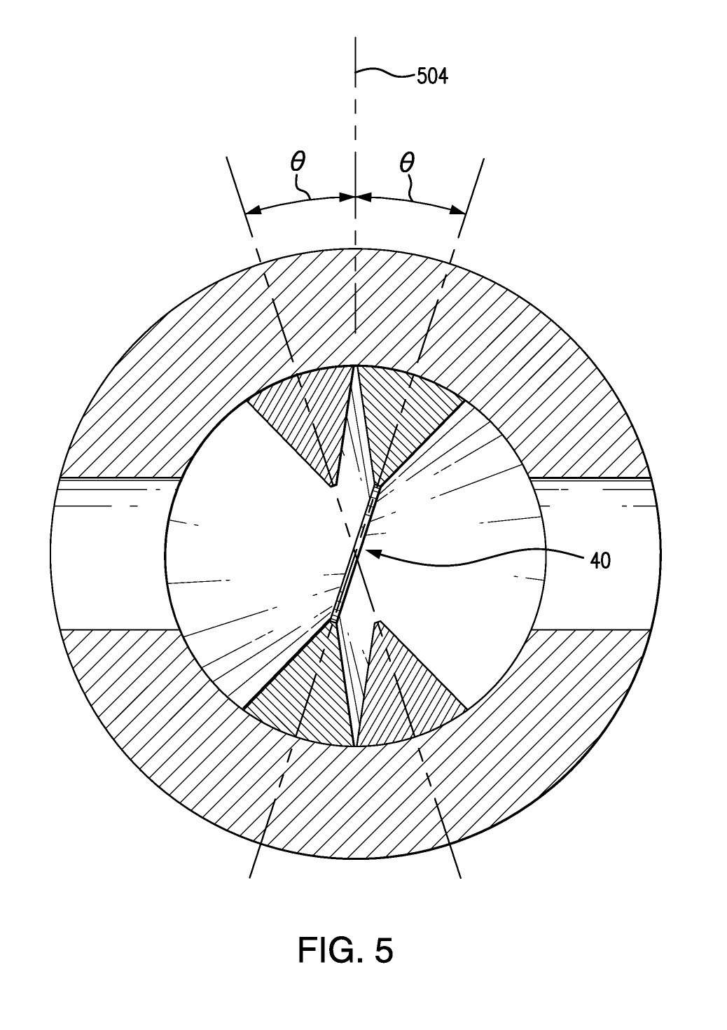

The first cutter 20 is an exemplary test fixture which demonstrates exemplary shape and positioning of cutting edges during cutting. The cutter 20 has a generally tubular body 22 with a transverse through-aperture 24 for accommodating the rod 25 of FIG. 4 or other elongate article to be cut. An exemplary rod is a monolithic (e.g., as distinguished from stranded cable) metallic shaft of circular cylindrical section or near cylindrical section. For example, in surgical cutting applications, variations on a pure circular cylindrical rod may include textured surface rods, rods of fluted or polygonal cross-section, threaded rods, and the like (in either straight or curved form). However, the exemplary article being cut consists essentially of a metallic shaft (e.g., optionally coated). Nevertheless, other articles may be cut, including non-monolithic structures and non-metallic structures. The suitability of any particular material to be cut by any particular embodiment may vary with material properties.

First and second cutting elements 26, 28 extend through opposite first and second ends 30, 32 of the body. The cutting elements may be referred to as jaws. Alternative implementations (e.g., discussed below) place the cutting elements as inserts into jaw bodies. In such a situation, the term “jaw” may identify the jaw body, the insert, or their combination/assembly as may be appropriate in context. Each element 26, 28 has an exemplary concavely arcuate cutting edge 40 at an inboard end 42. The outboard end 44 protrudes beyond the rim of the body allowing external force to be applied across the two outboard ends to engage the edges against the rod and ultimately cut the rod. Viewed along the axis of the body, the edges are off-normal to the rod axis 502 by an angle θ (FIG. 5) in opposite directions (e.g., so that they cross each other viewed in superposition). Exemplary θ is 10-40°, more narrowly, 15-25° or about 20°. For symmetric inserts and/or mounting of inserts, the off-parallel angle is 2θ so such a 10° minimum angle leads to having the edges off-parallel to each other by a minimum angle of 20°.

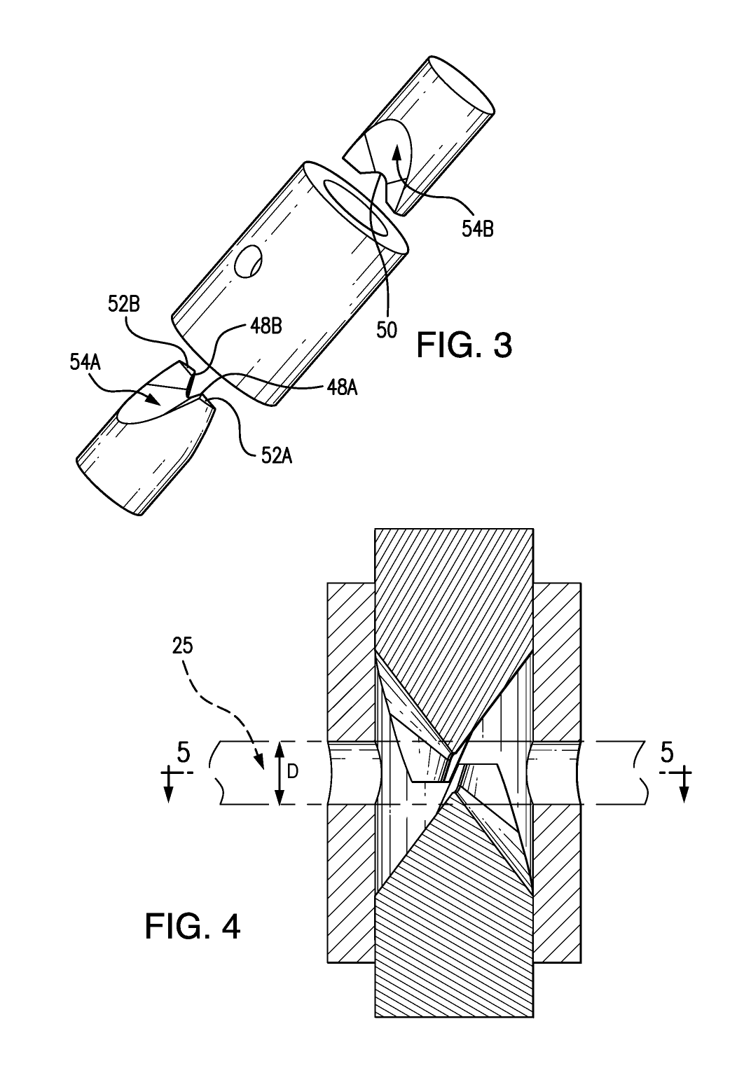

Each cutting edge has first and second distal (or end) portions 48A, 48B (FIG. 3) (shown as straight) and a central proximal (or base) portion 50 (shown as arcuate and concave). The distal portions are adjacent associated ends 52A, 52B of a generally U-shape structure and forming the associated distal end of the insert. On opposite sides of the edges, the insert has scallop-like reliefs 54A, 54B tapering toward each other toward the cutting edge. The concavity of the edges is dimensioned to cut a particular size (e.g., diameter) or size range of rod or other workpiece. During cutting, the distal portions of the two elements bypass each other (e.g., when viewed in superposition along the axis of the rod). For example, when viewed with the body axis 500 vertical, to one side of the rod (e.g., the left side) the associated distal portion of the first element may bypass in front of the associated distal portion of the second element while, to the opposite side, the associated distal portion of the second element may bypass in front of the first element (or first element bypass to rear of second). Such front and rear bypass may, alternatively, be described as to respective sides when viewed along the axis of the body with the rod axis extending transversely.

In the exemplary implementation, the end portions 48A, 48B are at approximately a right angle to each other. An exemplary angle is between 80° and 120°, more narrowly, between 90° and 100°.

The exemplary inserts are unisex moieties (i.e., the two inserts used together are identical rather than, for example, being non-identical mirror images). However, other implementations could involve non-identical moieties such as mirror images or asymmetrical combinations. Thus, in the claims below, except where the claim indicates the two jaws or jaw inserts are identical they should not be treated as identical. For example, if the first edge of one jaw is asserted as being adjacent the first edge of the other jaw, this should not be read as requiring that they are identical moieties and the same first edges are involved.

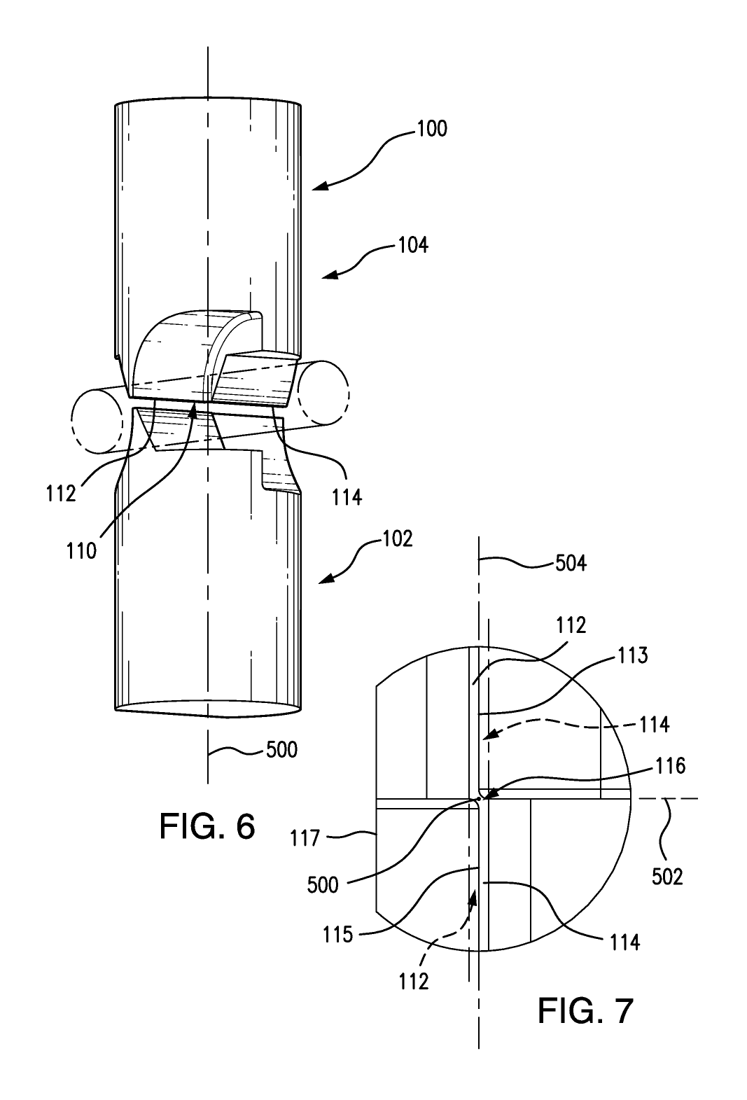

The bypass cutting is a form of shearing wherein the two cutting edges bypass one aside the other. Shearing without bypass is also possible. FIG. 6 shows a second cutter 100 (body removed) otherwise similar to the cutter 20 but wherein the cutting elements 26 and 28 are replaced by elements 102 and 104 (e.g., also identical moieties). Shearing is, for example, distinguished from a straight pinch compression (which technically does impart shear forces within the material but does not involve a net shear of the article). For example, a conventional bolt cutter involves a pinch whereas bringing two blades together aside or internally spaced apart from each other without bypass still imparts a shear. For purposes of illustration, the tubular body 22 is not shown. Each of the elements 102, 104 has a cutting edge 110 including a first portion 112 and a second portion 114. The edge portions 112 and 114 are offset from each other on opposite sides of a cutting plane 504. The actual cutting edges (corners of the cross-section) 113 and 115 of the respective edge portions 112 and 114 may fall essentially along the plane 504. The exemplary edge portions are parallel to the cutting plane and straight and normal to the axes 502 and 500. The edge may include a central portion 116 joining the portions 112 and 114. FIG. 7 shows, superposed in broken line, the edge portions 112 and 114 of the cutter 104 shown in relative position to those of the cutting element 102. In this exemplary implementation, there is no bypass. However, the offset provides shearing. The opposite offset of the edge portions 112 and 114 of one cutting element relative to the edge portions 114 and 112 of the other (and the associated oppositely offset shearing actions) tends to counter torques and, therefore, requires a substantially less robust apparatus than if a single shearing orientation is involved. For example, one may imagine using a pair of scissors or a shearing wire stripper to attempt to cut a robust rod or wire. With the absence of stabilization provided by the present oppositely offset shearing actions, the blades will easily be driven/bent laterally apart and the article being cut will tend to strongly rotate about an axis normal to its longitudinal axis. The oppositely offset shearing can greatly reduce this tendency.

Whereas the offset opposed bypass action of the cutter 20 allows the initial position of the jaws to have slight bypass and, thereafter, maintain their orientation as they descend, the lack of bypass in the test cutter 100 requires an additional means to angularly orient the elements 102 and 104. In the exemplary implementation, this is achieved by providing a lateral flat 117 along a chord of the circular cross-section of the elements which registers with a corresponding flat (not shown) in the interior of the body (not shown).

Such an offset is effectively shared by the cutter 20 which further provides bypass. The offset of the first cutter 20 is an angled offset rather than the parallel offset of the second cutter. FIGS. 2 and 5, for example, show the bypassing edge portions as being offset to opposite sides of the plane 504. Thus, whereas the superposed edges of the two cutting elements of the cutter 20 provide an X pattern, the superposed cutting edges of the two elements 102 and 104 form more of an H. Yet further variations may involve hybrids of these two concepts (the X pattern of cutter 20 and the H pattern of cutter 100). FIG. 8 schematically shows the X cutting pattern of the first cutter and the H cutting pattern of the second cutter. Although the corners of the edges of the second cutter fall essentially at the cutting plane 504, the edges have thicknesses and the centers of contact of those edges with the rod are spaced apart from the plane 504 thereby potentially imparting torques. For purposes of illustration, points 550A and 550B represent the average contact points for the respective two portions (on opposite sides of the rod) of one insert of each cutter whereas 552A and 552B represent the average contact points for the respective edge portions of the cooperating insert. For simplification, these are shown in the same locations for the X-pattern and the H-pattern to illustrate how similar torque/twisting distributions may be imparted to the rod by both patterns. The separation of points 550A and 552A across the cutting plane 504 show a first shearing action and provide an associated moment about a front-to-back axis along the plane 500. The separation of the points 550B and 552B provides an opposite shearing action and an opposite torque.

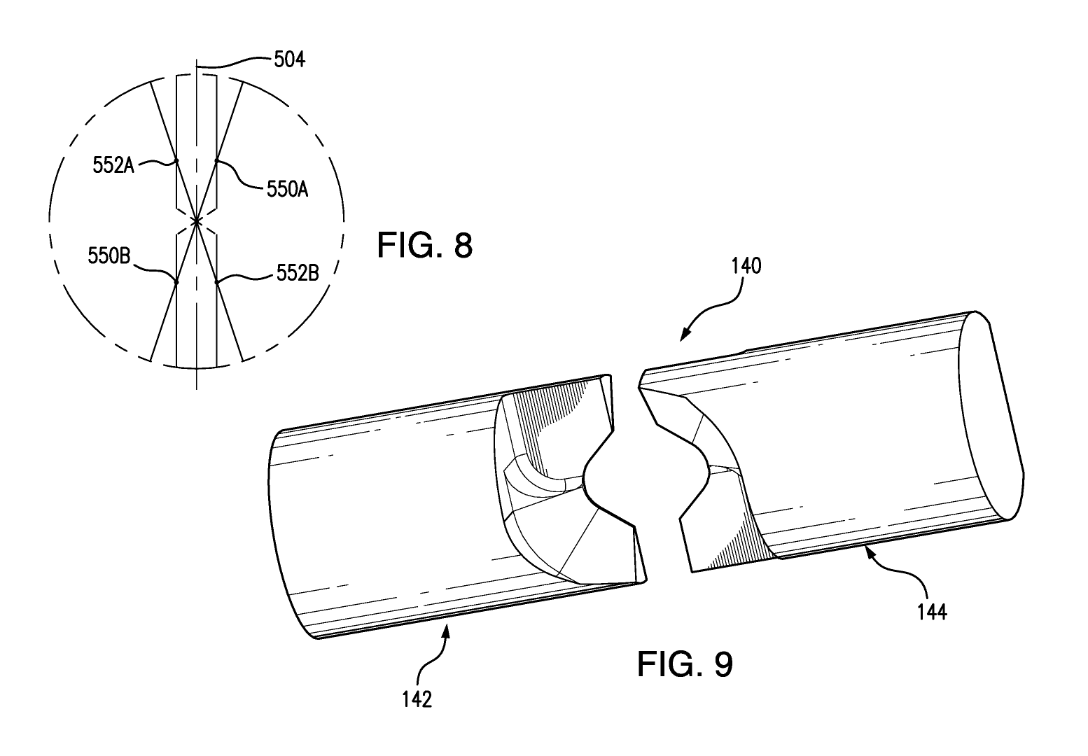

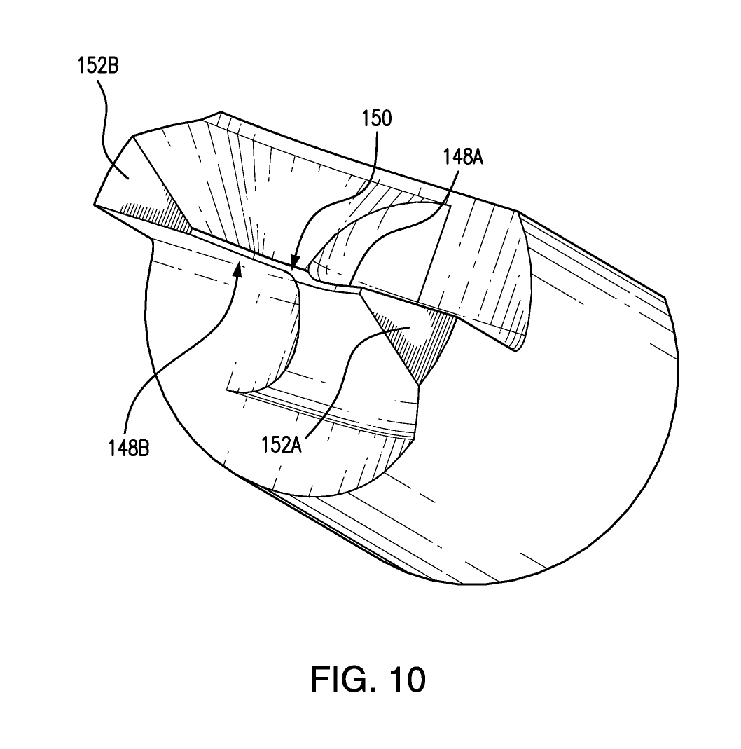

FIGS. 9 and 10 show a third test cutter 140 (body removed) sharing the offset parallelism of the cutting edges of each given element 102 and 104 of the second cutter 100 with the alternating/opposite bypass action of the cutting elements 26 and 28 of the first cutter. To facilitate this bypass, the connecting/joining central portion and adjacent portions of the two parallel edges it joins are recessed thus also having a generally U-shaped structure 150 between distal ends 152A and 152B of the cutter and cutting edge portions 148A and 148B.

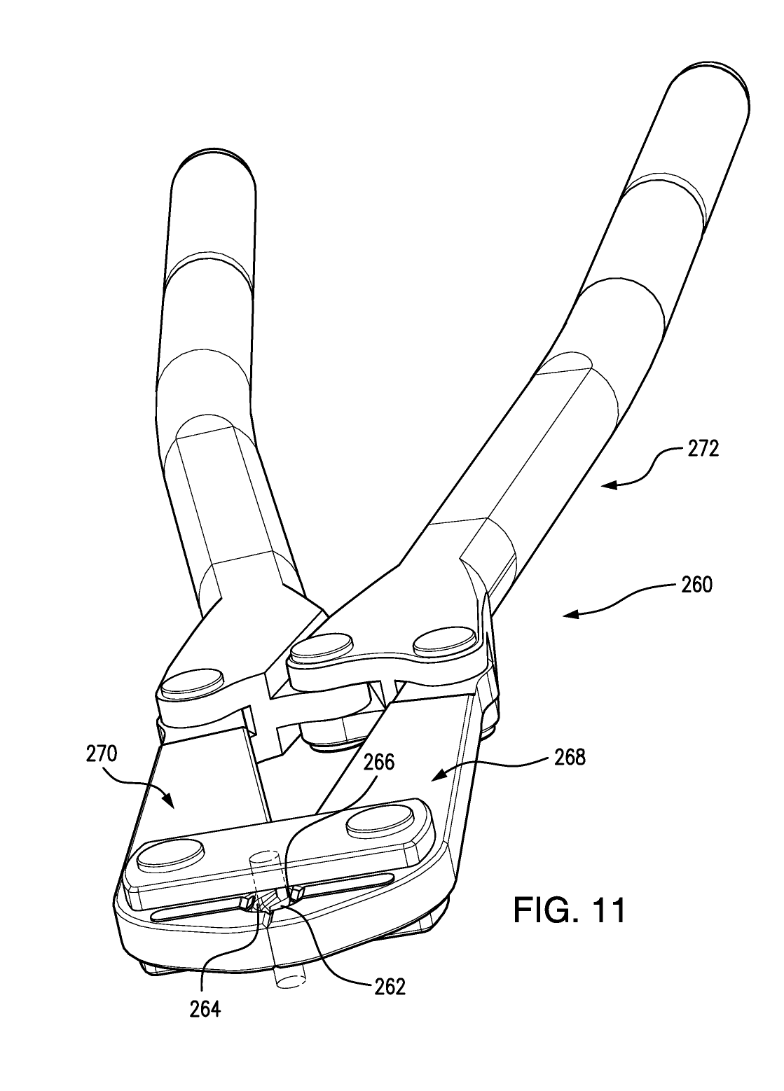

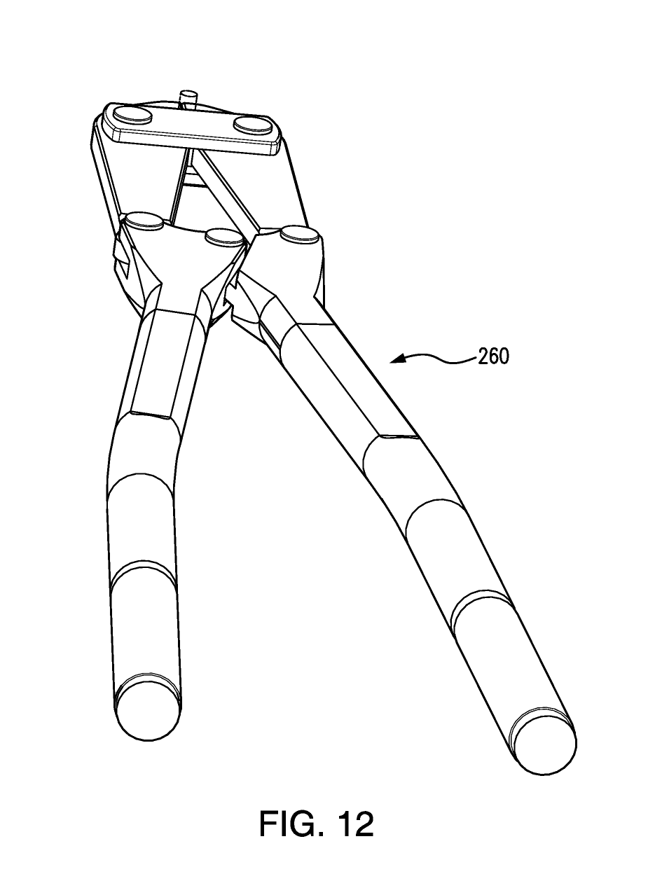

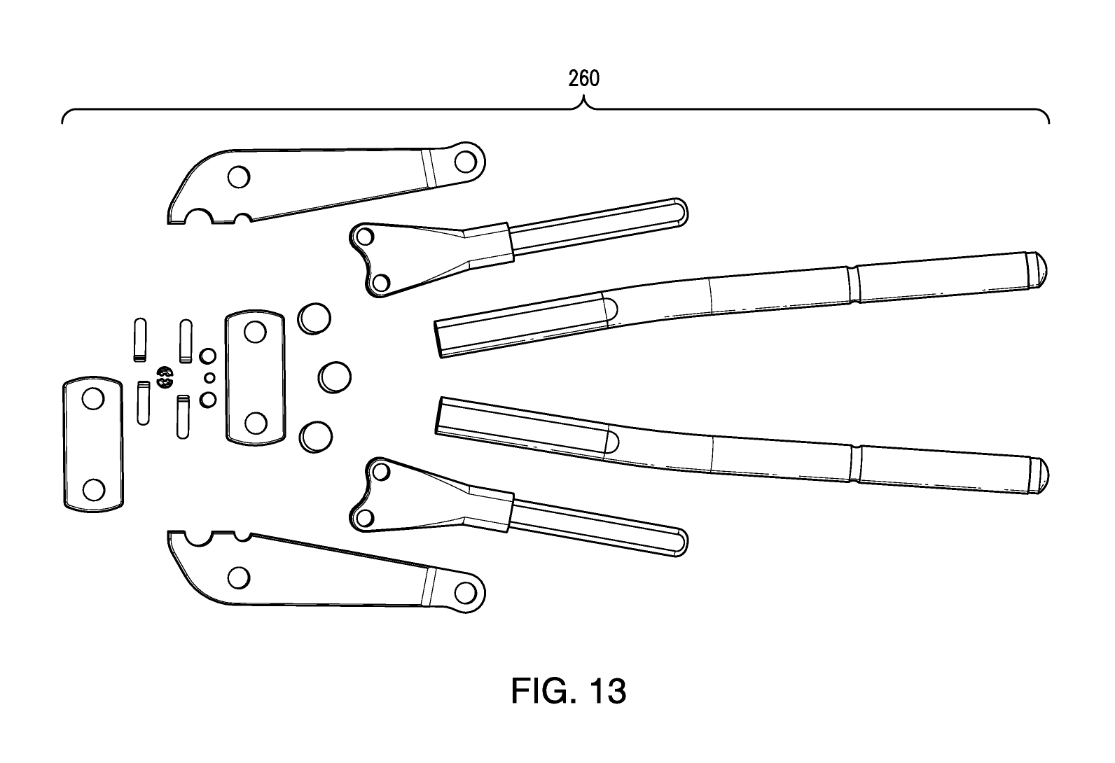

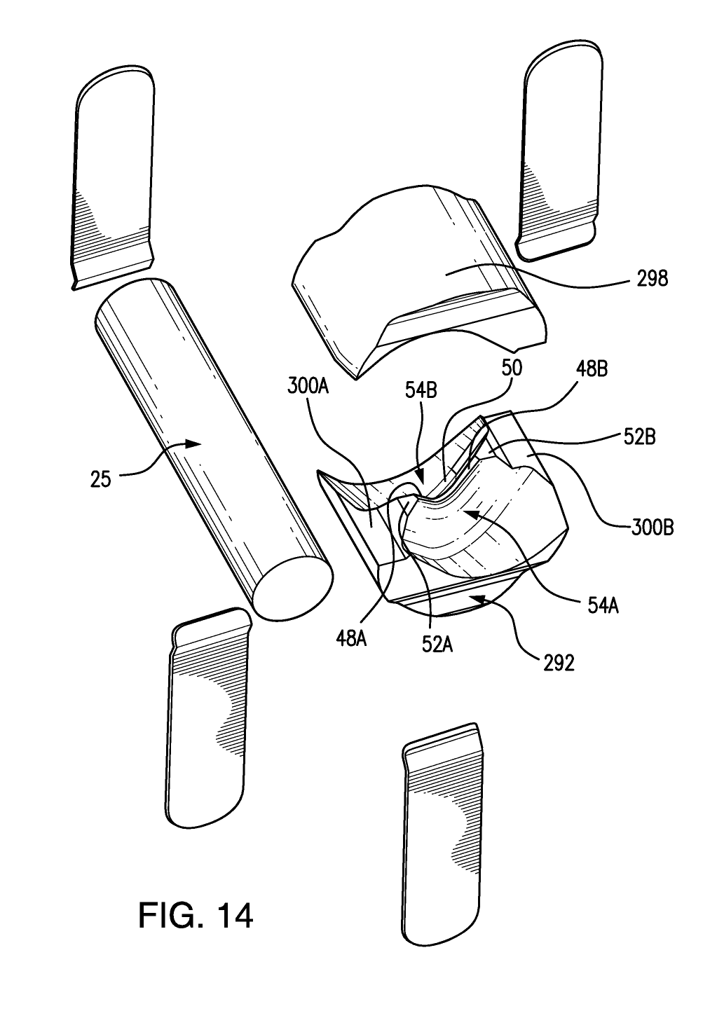

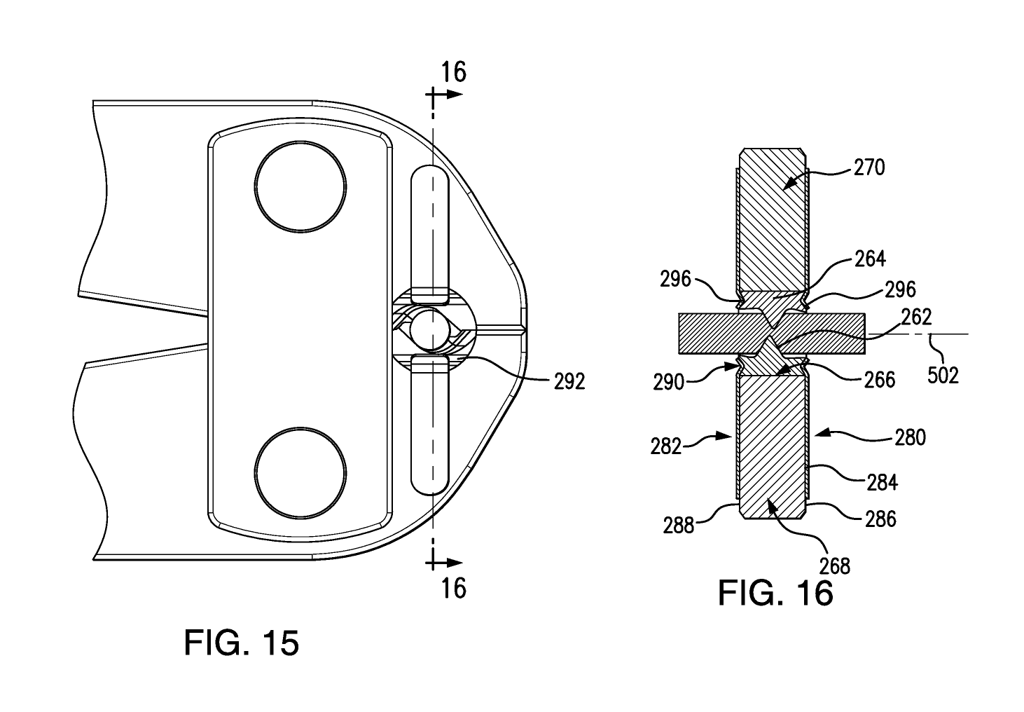

Such a cutting action may be applied to other cutters. For example, a cutter 260 (FIG. 11) involves shorter versions of the elements 26 and 28 as inserts 262, 264 installed in associated compartments 266 in respective first and second jaws 268, 270 (jaw bodies) of a conventional bolt cutter-style cutting device 272. The baseline (conventional) cutting device is modified by machining the compartments 266 (e.g., as cylindrical half rounds or other chord sections of a cylinder). To retain the inserts, a retention mechanism is provided. An exemplary retention mechanism comprises, for each jaw, a pair of clips 280, 282 (FIG. 16). Exemplary clips are formed of bent stainless spring steel. Clip proximal portions 284 are respectively secured along first 286 and second 288 lateral faces of each of the jaw bodies (e.g., via welding). Exemplary distal portions 290 of the clips protrude along the associated compartments and are received in adjacent groove-like recesses 292 (FIG. 14) in opposite end portions 294 and 296 of the associated inserts. Each insert 262, 264 has a proximal end shaped and dimensioned for mating with the associated compartment 266 (e.g., a surface portion 298 of a circular cylinder). The exemplary cutting edge retains the distal portions 48A and 48B and the central portion 50 of the cutting elements 26, 28. End portions 52A and 52B are also shown. There are reliefs 54A and 54B on opposite sides of each cutting edge. The end portions protrude above adjacent shoulders 300A, 300B (e.g., positioned to align with the adjacent face of the associated jaw body). For example, these may be outboard portions of an essentially diametric (or other chord) face of the cylinder forming the surface 298. A cutter kit may include the cutter 260 and several sets of inserts for corresponding rod sizes.

When the cutting action is viewed from the side of the cutter, to one side of the rod near the opening of the jaw there is one bypass (with the edge of one of the two inserts passing in front of the edge of the other); whereas to the other side of the rod (a proximal side near the hinge mechanism/axis) the bypass is opposite/reversed. As is discussed above, this provides for enhanced stability and decreased tendency of the rod to rotate about a longitudinal axis of the cutting plane normal to the rod longitudinal axis.

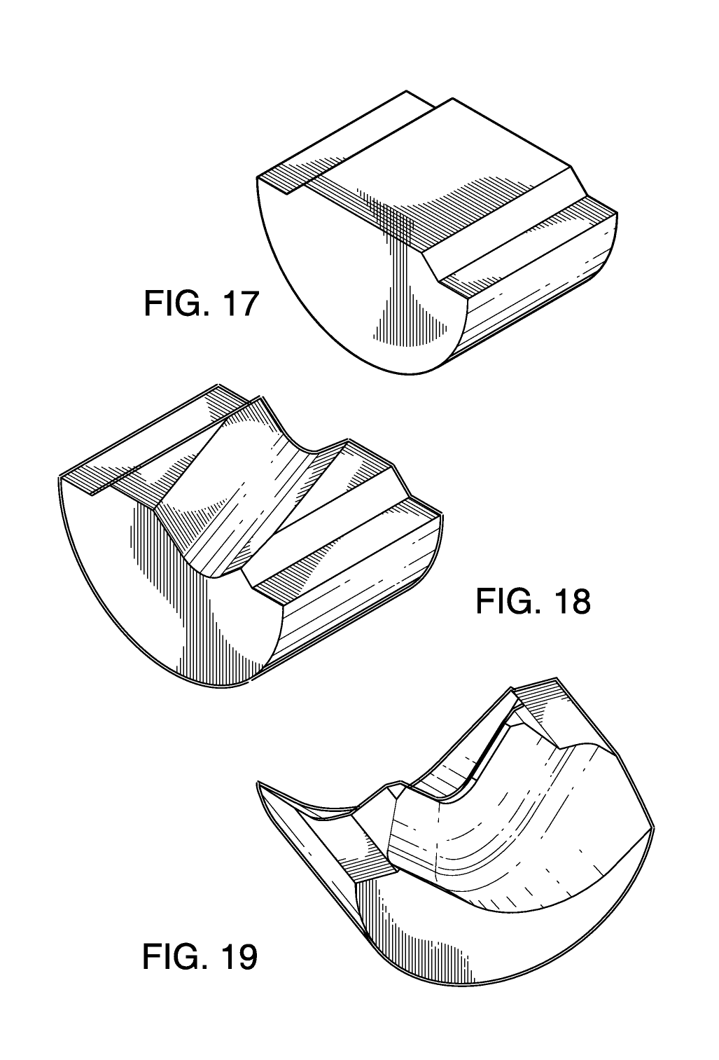

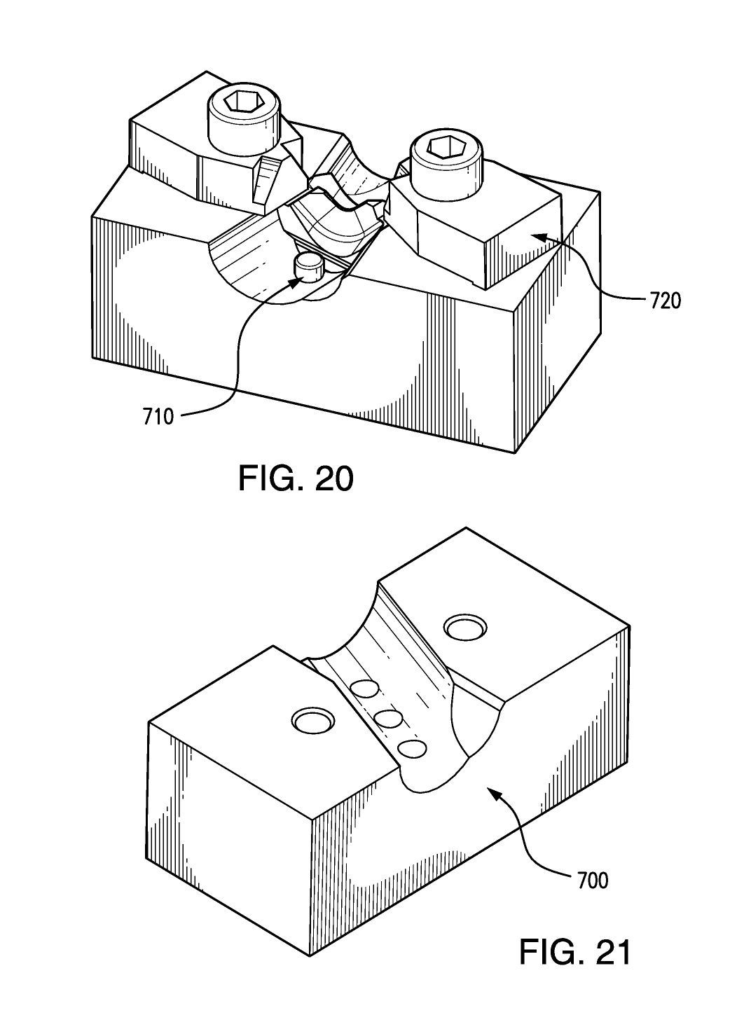

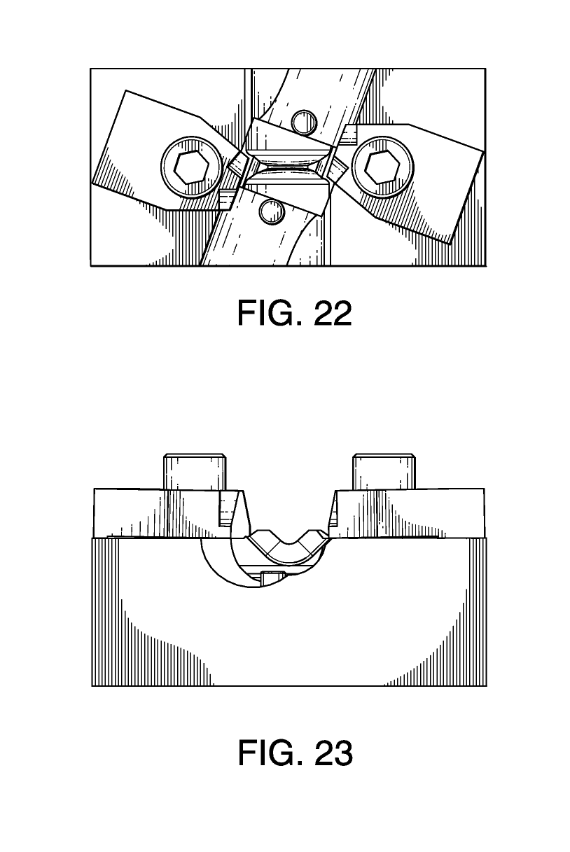

FIGS. 17-19 show exemplary stages in the manufacture of the cutting inserts. FIGS. 20, 22, and 23 show a fixture for manufacturing the cutting inserts and FIG. 21 shows a body of the fixture. The exemplary body 700 comprises a right parallelepiped metallic block into one of the larger faces are machined a pair of channels (one channel directly transverse and one at an angle). Along the base of the latter channel, three holes are provided for accommodating retaining pins 710. Aside the channel on the associated face, holes are machined and threaded for retaining clips 720. In a method for forming the inserts 262, 264, one may start with circular cylindrical rod stock (e.g., a stainless steel such as 440C hardened to Rockwell C 55-60) of the appropriate diameter. This may be cut to length. The cut precursor may then be machined down to a desired longitudinal profile which forms precursors of the shoulders and a raised area therebetween (FIG. 17). The shoulders facilitate subsequent clamping in the machining fixture. The raised area forms precursors of the channel ends. In a third operation, an off-longitudinal groove (FIG. 18) is machined through the raised area to form the basic concavity of the edge. This may be performed in the fixture with the clips holding the respective shoulders 300A and 300B. While still in the fixture, the reliefs may then be cut (machined (FIG. 19)) with a correspondingly shaped end mill cutter. This may be performed with a correspondingly shaped milling cutter. If not already machined, the retention grooves 292 may be machined (e.g., in a conventional milling machine with a correspondingly shaped bit).

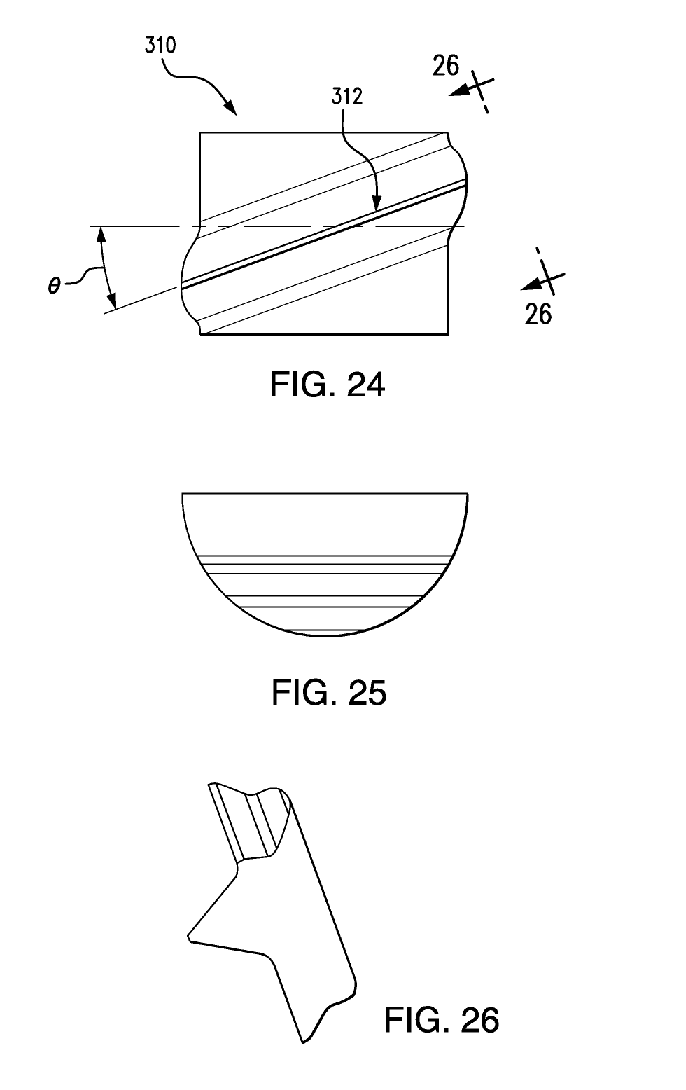

FIGS. 24-26 show an alternate cutting element or insert 310 which may be otherwise similar to the elements/inserts 262, 264 and may be interchangeable therewith in the cutter 260. The cutting edge 312 has a symmetric V-section oriented at the same angle θ discussed above. The apex of the V is slightly flattened to avoid damage. The edge 312, however, differs from that of the inserts 262, 264 in also being non-recessed and, therefore, a purely straight, non-arcuate edge. When two such inserts are brought together in the closing of the cutter 260, their edges form an X in superposition as discussed above thereby providing opposite shearing to either side of the rod and pinching in the center. However, there is no bypass.

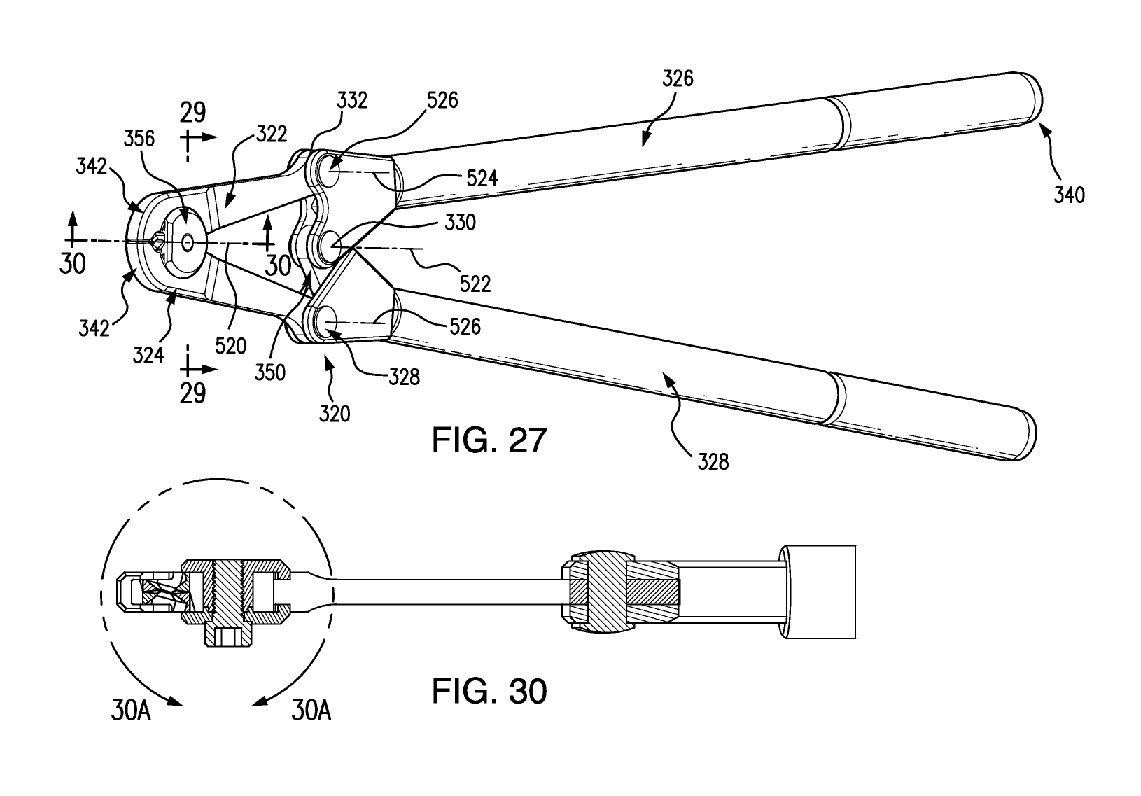

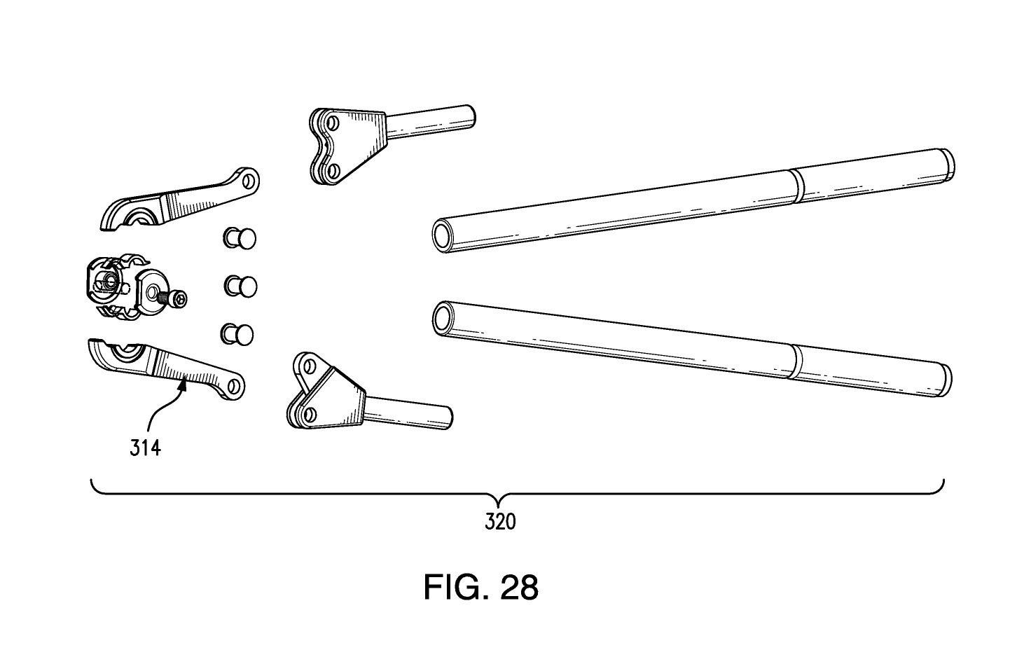

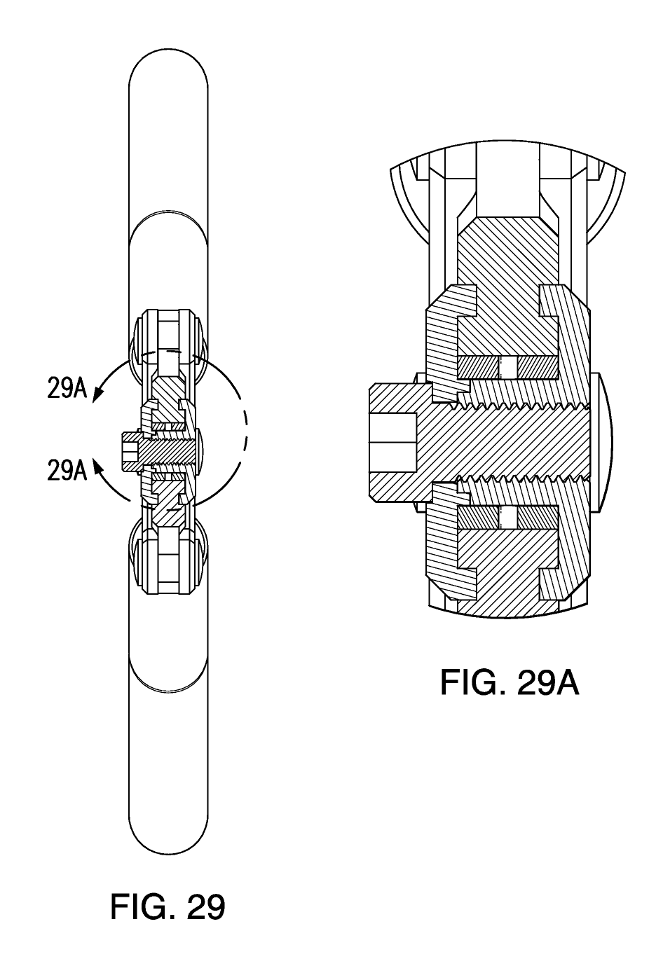

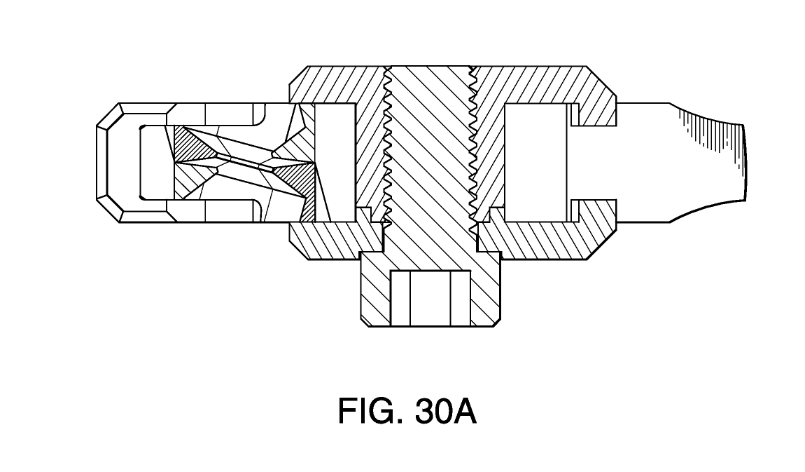

The reduced cutting force required (contrasted with a conventional cutter) permits a corresponding reduction in tool size (e.g., jaw dimensions and mass). Additionally, an improved hinge arrangement may permit a further reduction in size. This may allow smaller incisions and/or greater maneuverability when used in situ during surgery. The improved hinge of the cutter 320 of FIG. 27 eliminates the two hinge straps/plates of a conventional cutter. Rather than rotating about the two spaced-apart hinge axes of the traditional cutter, the jaws 322, 324 are hinged for relative rotation about a single axis 520. FIG. 27 further shows a first handle 326 and a second handle 328 hinged relative to each other via a pin 330 for relative rotation about an axis 522. The respective first and second handles are hinged to driving ends 332 of their respective associated jaws 322 and 324 via pins 326 and 328 providing relative rotation about axes 524 and 526. Thus, by opening distal end portions 340 of the handles (pulling them apart from each other via rotation about the axis 522) the axes 524 and 526 may be brought closer to each other thereby bringing the ends 332 of the jaws closer to each other and rotating them about the axis 520 which, in turn, brings cutting ends 342 of the jaws apart (to an open condition of FIG. 34). Conventional tool manufacturing techniques and materials may be applied. The exemplary hinging of the two handles is symmetric across a medial plane of the tool that extends through both jaws and handles so as to avoid racking. This may be achieved by providing the proximal end of one of the handles with a tongue structure 350 received in a yoke structure of the opposite handle to combine with the pin 330 and associated apertures to provide the hinge mechanism between the handles. Similarly, the handles form respective yoke structures receiving the ends 332 of their associated jaws. Each jaw 322, 324 comprises a jaw body (e.g., a single metallic piece 354 (FIG. 28)) and an associated separable cutting element/insert (discussed below). In the exemplary implementation, the jaw bodies 354 are identical to each other and are machined, for example, from stainless steel, titanium alloy, or the like.

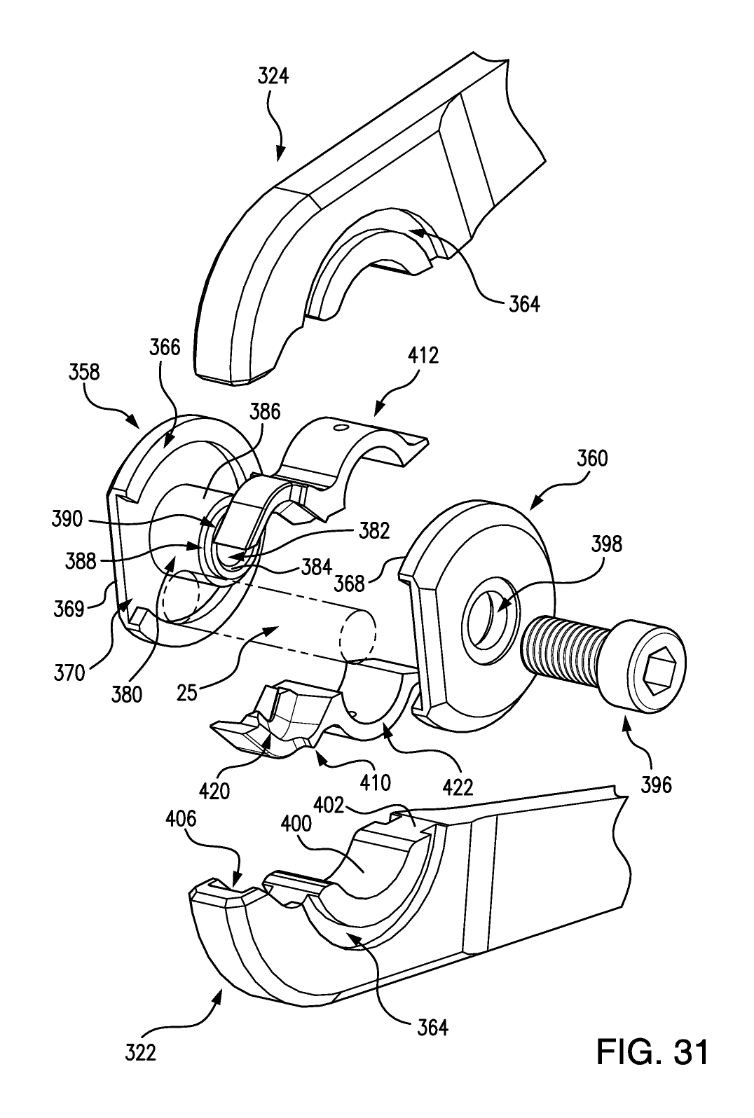

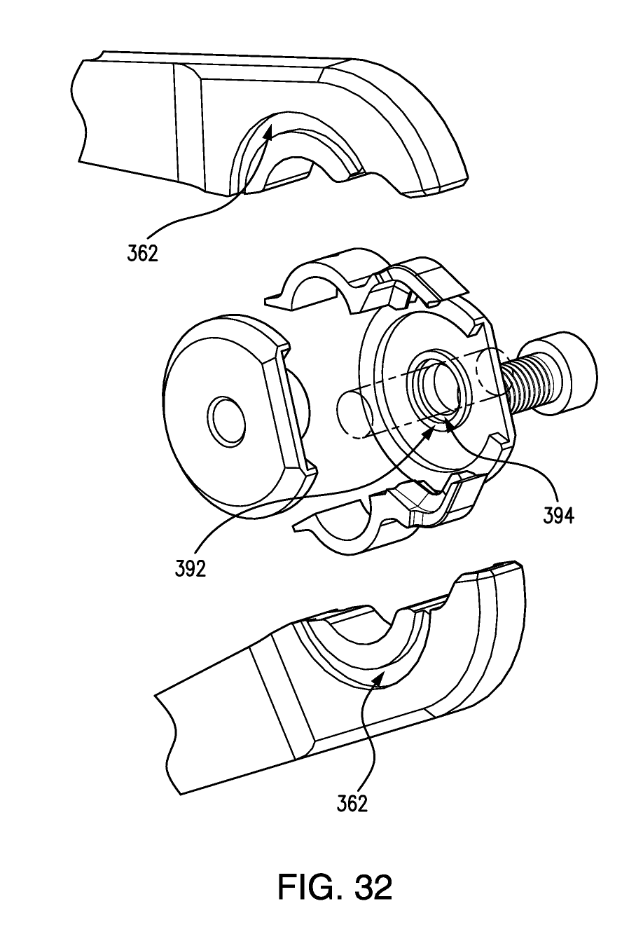

The exemplary jaw hinge mechanism 356 comprises a first side member 358 (FIG. 31) and a second side member 360 respectively to a first side of the two jaws and a second side of the two jaws. In exemplary implementation, each of the side members interfits with both bodies along its associated side of the jaws to retain the jaws for rotation about the hinge axis 520. The exemplary interfitting comprises an annular channel 362 (FIG. 32, e.g., a single annular channel) along the first sides (lateral surfaces) of the jaws (more particularly the jaw bodies) spanning the gap between the jaws or jaw bodies. Thus, a first portion of each channel is along the first jaw and a second portion of such channel is along the second jaw. A similar second channel 364 (FIG. 31) is along the second sides of the jaws. The first side member has an annular projection (protrusion) 366 which is received in the first channel and the second side member has an annular projection (protrusion) 368 received in the second channel. As is discussed elsewhere, the reference to “first” and “second” is somewhat arbitrary and non-limiting. For example, with the two jaw bodies manufactured as identical pieces, the face/surface that forms the first surface of one jaw forms the second surface of the other jaw as used above in this paragraph. However, it might alternatively be referenced that a given channel extends through the first surface of one jaw and the second surface of the other jaw so long as those two surfaces are to the same side of the jaw assembly.

The exemplary annular projections are “annular” in that they form at least a partial annulus effective to rotate about an axis within the associated channel while radially retaining the side member to the associated jaw(s). The annularity need not be a full annulus. For example, in the exemplary implementation, the side members have a planform corresponding to a portion of a circle after cutting at a chord. Thus, the exemplary annular projections are portions of a full annulus (e.g., approximately 270° of annulus, more broadly, 220-280° or 200-320°). As is discussed below, the side members may be machined of stainless steel or an aluminum or titanium alloy such as via turning for rotationally symmetric features (e.g., on a lathe) followed by milling the side member along a chord 369 to leave an opening 370 in the projection 366 or 368 between ends of such projection (which, in the illustrated embodiment are then radially milled). The exemplary projection cross-section is rectangular as is the exemplary cross-section of the annular channels.

The two side members may be secured to each other directly or indirectly via a central shaft which may be separately formed from or formed as a portion of one or both side members. The exemplary central shaft is formed by bosses of the two side members assembled via a fastener. In the exemplary implementation, the two side members are asymmetric in that one side member (358) comprises a centrally apertured inwardly projecting boss 380. The central aperture 382 of the boss 380 bears an internal thread 384. The exemplary boss 380 includes a relatively large diameter proximal portion 386 and a shoulder 388 forming a relatively smaller diameter and relatively short length neck or distal portion 390. The other side member (360) includes a shorter boss 392 having an internal shoulder 394. The boss 392 has an outer diameter (OD) similar to that of the proximal portion 386 of the other boss. The boss 392 may receive the neck portion 390 of the boss 380 to register the two side members. A threaded fastener 396 (e.g., a socket head cap screw) may extend through an aperture 398 in the latter side member and be received in the threaded bore of the former side member to secure the two side members together and thereby sandwich the jaws therebetween to retain the jaws. In the assembled condition, the cooperation of the projections 366, 368 with the channels 362, 364 constrains relative movement of the jaw bodies and jaws to rotation about the hinge axis 520 which is the central longitudinal axis of the bosses and the fastener so as to provide a hinge mechanism.

The side members may also cooperate with the jaw bodies to retain the cutting inserts. The exemplary jaw bodies have a concave cylindrical surface portion 400 which, in the assembled condition, is spaced radially apart/outward from the outer diameter (OD) surface of the central shaft (the combined bosses (e.g., the proximal portion 386 of the first boss 380 plus the second boss 392)). The gap between the surface 400 of each jaw and the bosses may be used to retain the cutting inserts 410, 412.

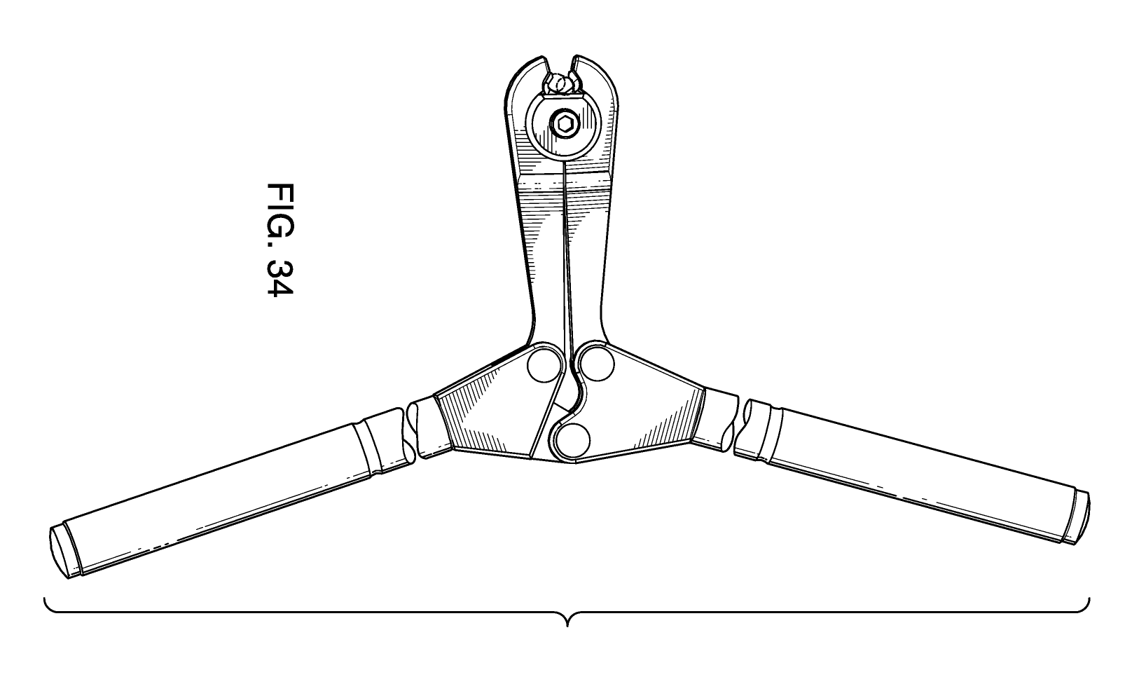

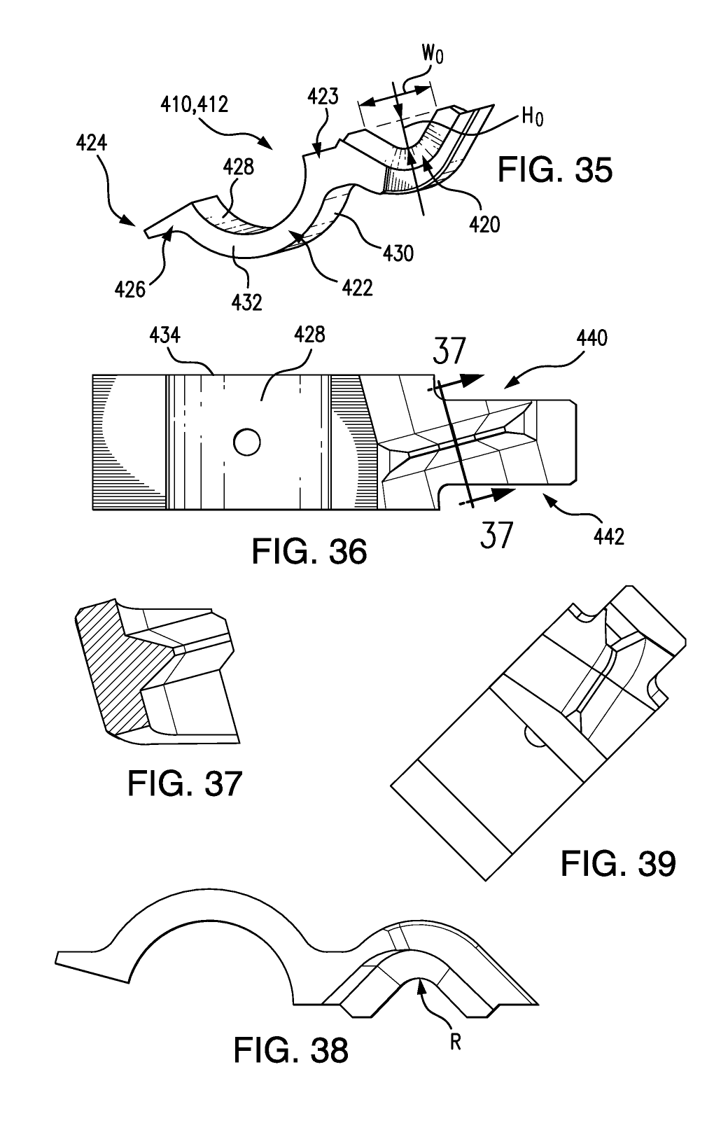

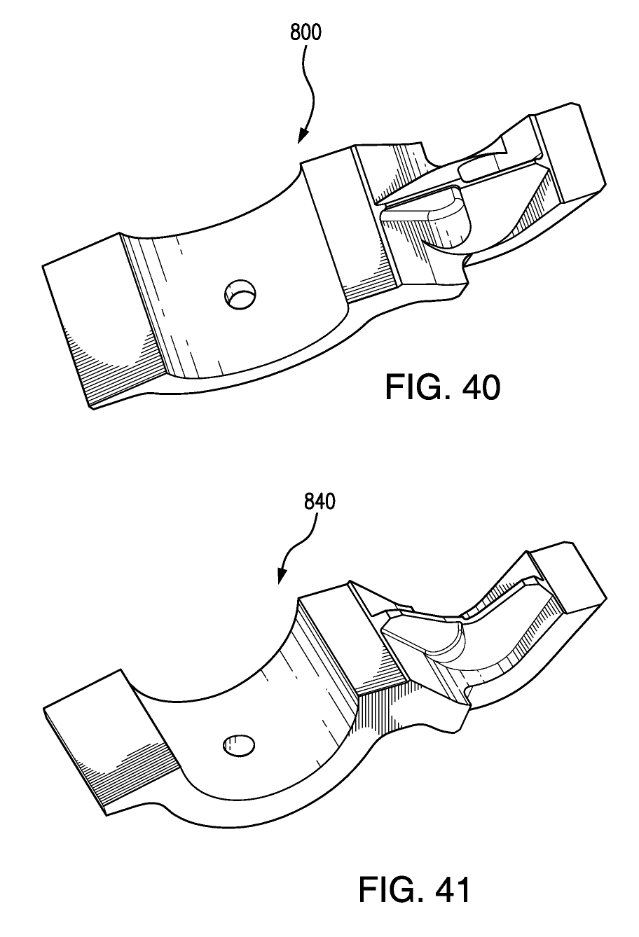

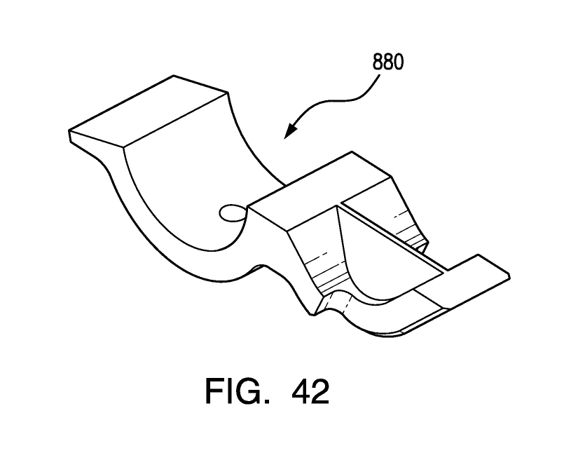

An exemplary cutting insert 410, 412 (FIG. 31, identical in the exemplary embodiment) comprises the combination of a cutting portion 420 which may be generally similar to those described above and a retaining portion 422. The exemplary inserts are shown in further detail in FIGS. 35-38 and have a similar cutting edge to that of the inserts 26, 28, 262, 264. The exemplary insert 800 of FIG. 40 has the straight offset cutting edge/action of the inserts 102 and 104. The exemplary insert 840 of FIG. 41 has the combined geometry and action of the insert 140 of FIGS. 9 and 10. The insert 880 of FIG. 42 offers a conventional laterally symmetric longitudinally-oriented V-on-V pinch cutting action without shear. This insert 880 merely indicates that the basic tool of FIG. 27 may be used with inserts providing conventional actions such as conventional pinch cutting actions, conventional bypass shearing, conventional crimping, and the like. Yet other variations involve asymmetric V-sections as are present in some bolt cutters.

The exemplary cutting 420 and retaining 422 portions are unitarily formed as a single piece (e.g., of insert material discussed above). The exemplary retaining portion is arcuate, extending from a proximal end 423 at an associated end of the cutting portion. The exemplary retaining portion extends to a distal end 424 having an at least partially radially protruding tab-like structure (tab) 426. Between the tab-like structure and the cutting portion, the retaining portion has a generally concave first surface 428 and an opposite convex second surface 430 (and lateral surfaces 432&434 which are portions of the associated lateral surfaces of the insert as a whole).

With the exemplary improved hinge system, the convex second surface 430 mates with the concave ID surface 400 of the associated jaw and the concave first surface 428 closely accommodates/receives the central shaft or sleeve of the hinge surface (i.e., the combined outer surface of the bosses). When installed/seated, the tab 426 helps rotationally retain the cutting insert to the associated jaw body against relative rotation about the hinge axis (e.g., an underside of the tab engages/contacts an adjacent portion 402 of the inboard surface of the jaw body toward the proximal end of the jaw body). Near the distal end of the jaw body a radially inwardly open pocket 406 is formed which receives a narrowed distal portion of the cutting insert (e.g., narrowed by a pair of machined lateral rebates 440, 442 (FIG. 36)). This helps further laterally retain the inserts. The close accommodation of the retaining portion between the associated jaw body and the central shaft or sleeve prevents translation in the cutting plane and the clamping of the retaining portion between the side members prevents lateral/transverse movement.

Various conventional tool making techniques may be used to make the tools and inserts. The exemplary cutting inserts of FIG. 35 may be made via machining from bar/strip stock rather than the aforementioned rod stock of like composition. Gross features, including features of the retaining portion may be machined via a conventional milling. Thereafter, the insert (precursor) may be installed in a fixture generally similar to that described above but including a relieved area for accommodating the retaining portion. Edge details may then be machined as described above. The exemplary inserts of FIG. 35 show an aperture which may be used to retain the insert in a fixture during later stages of machining.

With the exemplary recessed cutting element and cutting edge of FIG. 35, the recess is shown having a width W_{O} at its opening and a depth H_{O}. With the exemplary single aligned recess in both opposed elements, jaw geometry (e.g., in one aspect expressed in terms of these parameters and the tightness of the recess bottom (e.g., radius R (FIG. 38) of curvature)) may cause the jaws to bear certain relationships to the rod to be cut. With an exemplary circular rod of diameter D, exemplary W_{O} is at least 50% of D, more narrowly, at least 100%, although much smaller W_{O} may be useful merely to achieve slight bypass and/or a retention against the rod slipping forward (i.e., away from the hinge axis). In more particular examples, exemplary W_{O} is 50-200% of D or 120-200%. Exemplary W_{O} is ˜10 mm, more broadly, 7-12 mm for typical rods in the 5-7 mm diameter range. Exemplary H_{O} is ˜3 mm, more broadly, 2-4 mm for cutting such rods. Exemplary H_{O} is 20-50% of W_{O}. The geometry may be such that during the cutting action, an initial contact time/condition in the single cutting stroke (i.e., when the rod contacts and is clamped between the two jaws) is before any bypass has begun or after any bypass has begun. The angling of the edges forming opposite legs of each U of the recess may create a camming/ramping force magnifying their engagement force with the rod to be cut (compared with the force exerted by a straight linear, non-recessed edge) and thereby improving cutting. As a bypass begins, the two opposed cutting elements effectively create an aperture which contracts around the rod. Further variations of such a cutting action can be viewed as akin to the iris of a camera lens contracting. This brings up the possibility of alternative cutters having more than just the two jaws.

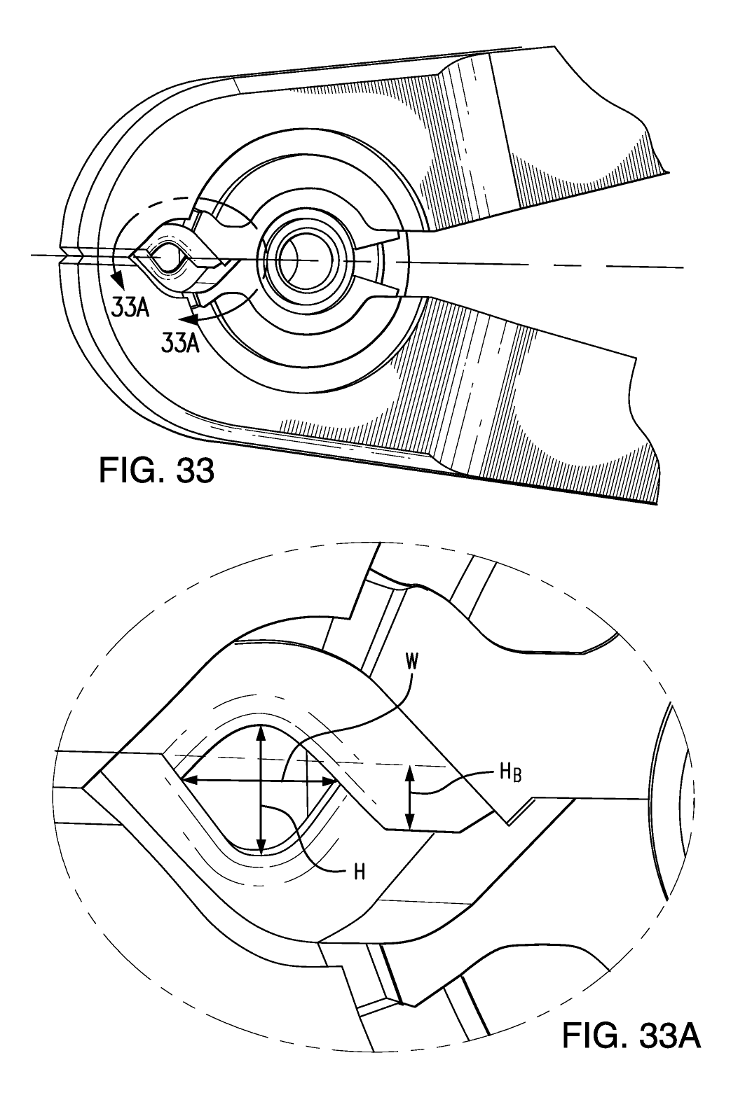

As the jaws bypass, the cutting aperture has a height H and a width W (FIG. 33A) which progressively decrease as the jaws close further. FIG. 33A also shows the depth of bypass as H_{B}. These need not go to zero. Rather in view of the material properties of the rod being cut, the two cut pieces may snap apart from each other even before the jaws fully close. Again, in the fully closed position, W and H need not be zero. At initial bypass in an exemplary cutter, H is essentially 2H_{O} (subject to slight departures from parallel movement due to hinging). At the fully closed position, H may be less than H_{O} (e.g., 30-150% or 30-100% or 40-80%) and less than 50% of D. Exemplary H_{B} is 1-2 mm with the exemplary 5-7 mm rod diameter (or similar transverse dimension for non-circular rod). During the closing, the two opposed edges of the two jaws on one side of the rod pinch the rod in the opposite direction of the two opposed edges on the opposite side of the rod thereby compressing the rod and both retaining it and facilitating the snapping severing action discussed above. During this cutting action, the edge portions can bypass at an angle to each other (e.g., in the vicinity of 80-120° or)90-100°. The hinging action of the tool itself may cause angular departures relative to the pure linear relative motion of cutting edges in the test cutters.

One or more embodiments of the present invention have been described. Nevertheless, it will be understood that various modifications may be made without departing from the spirit and scope of the invention. For example, when implemented in the remanufacture or reengineering of an existing cutter, details of the existing cutter may influence details of any particular implementation. Similarly, particular details of material being cut and the situation of cutting (e.g., a surgical environment) may influence details of the particular implementation. Accordingly, other embodiments are within the scope of the following claims.

1. A cutter (20; 100; 140; 260) having:
a first jaw (26; 100; 142; 262; 310; 410; 800; 840) having an edge having first and second portions; and
a second jaw (28; 102; 144; 264; 310; 412; 800; 840) having an edge having first and second portions, the first jaw and second jaw mounted relative to each other to articulate along a range of motion between an open condition and a closed condition,
wherein:
the first jaw first edge portion is offset from the second jaw first edge portion and the first jaw second edge portion is oppositely offset from the second jaw second edge portion.

2. The cutter (20; 100; 140; 260; 310) of claim 1 wherein:
centers of the respective first and second jaws move in a cutting plane and the first and second edges are respectively off-parallel to the cutting plane.

3. The cutter of claim 1 wherein:
the first edge first and second portions and second edge first and second portions are parallel to and spaced apart from a cutting plane.

4. The cutter of claim 1 wherein:
the first jaw and second jaw are mounted relative to each other to articulate along a range of motion between an open condition and a closed condition; and
during a terminal portion of the range of motion approaching the closed condition the first and second edges progressively overlap with opposite bypass between the first jaw first edge portion and second jaw first edge portion on the one hand and the first jaw second edge portion and second jaw second edge portion on the other hand.

5. A cutter for cutting a member, the cutter comprising:
a first jaw; and
a second jaw, the first jaw and second jaw mounted relative to each other to articulate along a range of motion between an open condition and a closed condition,
wherein:
the first jaw and second jaw are configured to provide a shearing action cutting between the first jaw and the second jaw on a first side of the member and an opposite shearing action cutting between the first jaw and the second jaw on a second side of the member opposite the first side.

6. The cutter of claim 5 wherein:
the first side is away from a hinge of the cutter and the second side is toward the hinge.

7. The cutter of claim 5 wherein:
the shearing action on the first side of the member comprises a bypass cutting; and
the opposite shearing action on the second side of the member comprises an opposite bypass cutting.

8. A cutter having:
a first jaw having a first edge; and
a second jaw having a second edge non-parallel to the first edge, the first jaw and second jaw mounted relative to each other to articulate along a range of motion between an open condition and a closed condition.

9. The cutter of claim 8 wherein:
centers of the respective first and second jaws move in a cutting plane and the first and second edges are respectively off-parallel to the cutting plane.

10. The cutter of claim 9 wherein:
during a terminal portion of the range of motion approaching the closed condition, the first and second edges progressively overlap in superposition normal to the cutting plane.

11. The cutter of claim 8 wherein:
the first and second edges are arcuate.

12. The cutter of claim 8 wherein:
central portions of the first and second edges are off-parallel to each other by at least 20° and intersect when projected on a central transverse plane of the jaws.

13. The cutter of claim 8 wherein:
the first and second edges are of respective first and second inserts of a first pair of inserts in respective jaw bodies of the first and second jaws.

14. The cutter of claim 13 having:
a first handle and a second handle; and
a compound hinge mechanism coupling the first handle and second handle to the first jaw and second jaw to magnify a compressive force applied across the handles into a greater compressive force applied by the jaw bodies across the inserts to cut a workpiece.

15. The cutter of claim 14 wherein the hinge mechanism includes an equipost coupling the jaws to prevent racking of the jaws.

16. A cutting system including the cutter of claim 13 and at least one additional pair of inserts interchangeable with the first pair of inserts and having arcuate edges of different curvature to those of the first pair of inserts.

17. A cutting system including the cutter of claim 13 and at least one additional pair of inserts interchangeable with the first pair of inserts and having non-arcuate edges, the first pair of inserts having arcuate edges.

18. A method for cutting a member, the method comprising, in a single stroke:
a shearing action cutting between a first jaw and a second jaw on a first side of the member; and
an opposite shearing action cutting between said first jaw and said second jaw on a second side of the member opposite the first side.

19. The method of claim 18 wherein:
the shearing action on the first side of the member comprises a bypass cutting; and
the opposite shearing action on the second side of the member comprises an opposite bypass cutting.

20. The method of claim 19 wherein:
in a region between the first side and the second side, there is no bypass.

21. The method of claim 18 wherein:
the member consists essentially of a metallic shaft.

22. The method of claim 21 wherein at least one of:
the metallic shaft is titanium-based, cobalt-based, or stainless steel; and
the metallic shaft is a rod of a spinal implant.

23. A tool (320) comprising:
a first jaw (322) having a first face and a second face;
a second jaw (324) having a first face and a second face; and
a hinge mechanism (356) coupling the first and second jaws for rotation relative to each other about a hinge axis (520) and comprising:
a first annular channel (362) in the first faces of the first and second jaws;
a second annular channel (364) in the second faces of the first and second jaws;
a first side member (358) having an annular protrusion (366) accommodated in the first annular channel; and
a second side member (360) having an annular protrusion (368) accommodated in the second annular channel.

24. The tool of claim 23 further comprising:
an actuator comprising:
a first handle (326) pivotally coupled to the first jaw for relative rotation about a first axis (524); and
a second handle (328) pivotally coupled to the second jaw for relative rotation about a second axis (526) and pivotally coupled to the first handle for relative rotation about a handle pivot axis (522).

25. The tool of claim 23 wherein:
the first and second jaws each comprise a jaw body and a cutting insert (410, 412; 800; 840; 880); and
each cutting insert comprises:
a cutting portion; and
a retaining portion, the retaining portion being arcuate and accommodated in the associated jaw body radially inboard of the first and second channels with respect to the hinge axis.

26. The tool of claim 25 wherein:
the arcuate portions combine to encircle at least 270° of a shaft member coupling the first and second side members.

27. A cutting insert (410, 412; 800; 840; 880) for use with a tool, the cutting insert comprising:
a cutting portion (420); and
an arcuate retaining portion (422) for retaining the cutting insert to the tool.

28. The cutting insert of claim 27 wherein at least one of:
the cutting insert consists essentially of the cutting portion and the retaining portion;
the retaining portion includes an arcuate body and a radially protruding tab;
the cutting portion has a cutting edge off-normal to an axis of curvature of the arcuate retaining portion;
the cutting portion has a first edge and a second edge offset from the first edge;
the cutting insert consists essentially of a single metallic piece;
the cutting portion has an arcuate cutting edge;
the cutting portion has a cutting edge having a central recess;
the cutting insert is a unisex moiety;
the cutting portion comprises a cutting edge protruding from a concave surface of an arcuate body portion;
the retaining portion has a concave surface extending at least 90° about an axis of curvature;
a pair of said cutting inserts are packaged together; and
first and second said cutting inserts are attached to respective first and second jaws of the tool.

29. The cutter of claim 5, wherein the first jaw and the second jaw each have a recessed cutting surface whereby the number is retained between the jaws during cutting.
